(19) United States
(12) Patent Application Publication
(10) Pub. No.: US 2004/0001390 A1
(43) Pub. Date: Jan. 1, 2004

(54) Electronic timepiece

(76) Inventor: Saburo Manaka, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/446,907

(22) Filed: May 28, 2003

(30) Foreign Application Priority Data
May 29, 2002 (JP) 2002-155211

(51) Int. Cl. G06F 1/04; G04F 5/00

(52) U.S. Cl. 368/157

(57) ABSTRACT

To be able to detect the presence or absence of rotation of a rotor in early stages. When a drive pulse is supplied from a driving circuit to a stepping motor for driving a chronograph hand, a rotor rotates, producing an induction voltage in a rotor-driving coil of an hour hand-driving stepping motor. A rotation detection circuit outputs a rotation detection signal indicating that the rotor has rotated when the number of zero cross points of the induction voltage during the period when a drive pulse is being supplied is more than a given number or a given time. When the number of the zero cross points does not reach the given number or a certain time comes, the circuit outputs a non-rotation detection signal indicating non-rotation to the control circuit. The control circuit receives the non-rotation detection signal from the rotation detection circuit and controls the driving circuit to drive the motor again with a higher-energy drive pulse.

### BACKGROUND OF THE INVENTION

The present invention relates to an electronic timepiece for rotationally driving fingers by stepping motors.

Conventionally, electronic timepieces for rotationally driving fingers by stepping motors have been utilized. The stepping motor has a stator provided with a rotor accommodation through-hole and a positioning portion for determining a rotor stop position, a rotor disposed within the rotor accommodation through-hole, and a coil. Drive pulses (alternating signal) are supplied to the coil to produce a magnetic flux in the stator. Thus, the rotor is rotated. The rotor is stopped at a position corresponding to the positioning portion.

Various functions are incorporated in recent timepieces (for example, electronic wristwatches). Included among them are a function of synchronizing the timepiece by rotating a stepping motor at a speed higher than normal and a function of returning to a zero-second position quickly after a chronograph measurement.

When the stepping motor is rotated at a high speed, it is necessary to make the interval between drive pulses extremely shorter than normal. Furthermore, error in rotation of the stepping motor should not exist.

Therefore, it is desired to construct it to detect the presence or absence of rotation of the rotor as the earliest time possible.

However, high-energy drive pulses (excessive power pulses) are supplied so that the rotor can be rotationally driven certainly. This makes it unnecessary to judge the presence or absence of rotation of the rotor.

Accordingly, supplying excessive power pulses to permit reliable rotational driving leads to a problem that electric power is wasted.

Furthermore, the interval between drive pulses is shortened. The next drive pulse is applied when the rotor is not yet brought to a full stop. Consequently, high-speed hand motion has limitations.

As the energy (voltage) increases, the rotor comes to a stop less easily. The operation falls into instability. Therefore, there is a problem that the allowable range of the operating voltage is narrow.

On the other hand, as a method of solving the above-described method, a method for detecting the presence or absence of rotation of a rotor is available as in an invention described, for example, in JP-B-62-9877. In this method, however, the presence or absence of rotation of the rotor is detected after rotational driving of the rotor has completed. Therefore, it takes a long time until the presence or absence of rotation is detected. This is unsuited for judgment on rotation of high-speed rotation.

It is an object of the present invention to be capable of detecting the presence or absence of rotation of a rotor in early stages.

It is an object of the invention to permit rotation of a rotor to be increased in speed by detecting the presence or absence of rotation of the rotor in early stages.

### SUMMARY OF THE INVENTION

According to the present invention, an electronic timepiece is provided which has a first stepping motor having a first rotor-driving coil wound around a first stator and a first rotor rotated by a magnetic flux produced in the first stator by a drive pulse supplied to the first rotor-driving coil and first driving pulse-producing means for supplying the drive pulse to the first rotor-driving coil, wherein a first finger is rotated by rotation of the first rotor, the electronic timepiece being characterized in that it comprises: a detection coil for detecting a signal induced by electromagnetic coupling with the first rotor-driving coil; and rotation detection means for detecting whether the first rotator has rotated or not, based on the detection signal produced in the detection coil. The detection coil detects the signal induced by electromagnetic coupling with the first rotor-driving coil. The rotation detection means detects whether the first rotor has rotated or not, based on the detection signal produced in the detection coil.

Here, the rotation detection means may be so configured that it detects that the first rotor has rotated when zero cross points of the detection signal are detected to be more than a given number while the drive pulse is being supplied to the first rotor-driving coil.

Furthermore, the first driving pulse-producing means may be so configured that it interrupts the drive pulse when the rotation detection means detects that the first rotor has rotated.

In addition, the first driving pulse-producing means may be so configured that it supplies a corrective pulse greater in energy than the drive pulse to the first rotor-driving coil when the rotation detection means detects that the first rotor is not rotating.

Furthermore, it may be so configured that it has a second stepping motor having a second rotor-driving coil wound around a second stator and a second rotor rotated by a magnetic flux produced in the second stator by a drive pulse supplied to the second rotor-driving coil and second drive pulse-producing means for supplying the drive pulse to the second rotor-driving coil, wherein a second finger is rotated by rotation of the second rotor, and wherein there is further provided switching means for causing the second rotor-driving coil to act as the detection coil.

In addition, the first stepping motor may be a stepping motor for driving a chronograph hand, and the second stepping motor may be a stepping motor for driving an hour hand.

### BRIEF DESCRIPTION OF THE DRAWINGS

A preferred embodiment of the invention will now be described with reference to the accompanying drawings wherein:

FIG. 1 is a block diagram of an electronic timepiece according to a mode of practice of the present invention; and

FIG. 2 are signal waveform diagrams showing the operation of the invention.

### DETAILED DESCRIPTION OF THE PREFERRED EMBODIMENTS

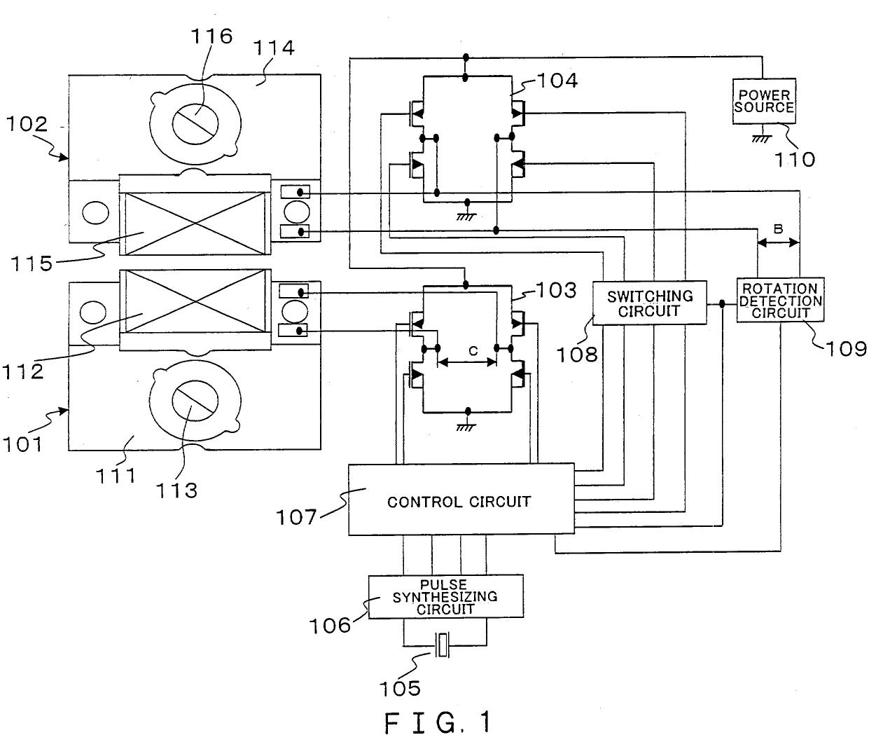

FIG. 1 is a block diagram of an electronic timepiece according to a mode of practice of the present invention, showing an example of an analog type electronic wristwatch operating using a battery as its power source and having chronograph functions.

In FIG. 1, the electronic timepiece has a stepping motor 101 acting as a first stepping motor and used to drive a chronograph hand, a stepping motor 102 acting as a second stepping motor and disposed close to the stepping motor 101 and operating to drive an hour hand, a motor driving circuit 103 for driving the stepping motor 101, a motor driving circuit 104 for driving the stepping motor 102, a pulse synthesizing circuit 106 having a quartz oscillator 105, a control circuit 107, a switching circuit 108 acting as switching means, a rotation detection circuit 109 acting as rotation detection means, and a power source 110 that is a battery. Here, the motor driving circuit 103, quartz oscillator 105, pulse synthesizing circuit 106, and control circuit 107 constitute first drive pulse-producing means. The motor driving circuit 104, quartz oscillator 105, pulse synthesizing circuit 106, and control circuit 107 constitute second drive pulse-producing means.

The motor 101 has a first stator 111, a first rotor-driving coil 112 wound around the stator 111, and a first rotor 113 rotated by a magnetic flux produced in the stator 111 by a drive pulse supplied to the rotor-driving coil 112.

The motor 102 has a second stator 114, a second rotor-driving coil 115 wound around the stator 114, and a second rotor 116 rotated by a magnetic flux produced in the stator 114 by a drive pulse supplied to the rotor-driving coil 115. Here, the rotor-driving coil 115 acts also as a detection coil.

Note that in the present mode of practice, the electronic timepiece has the plural motors 101 and 102 and so the structure is simplified by using the coil 115 of the motor 102 also as the detection coil for detecting the rotation of the rotor 113. In a case where there is only one motor, the timepiece may be so configured that a separate normal coil (that may be a coreless coil) is used to detect rotation of the rotor 113.

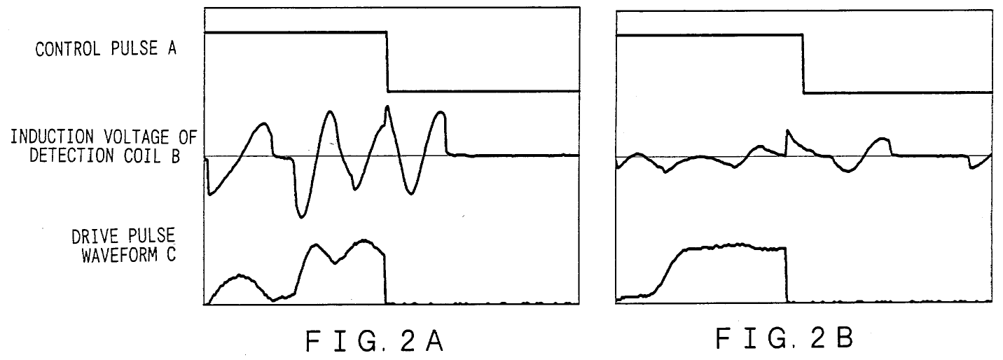

FIG. 2 are signal waveform diagrams for illustrating the operation of the present mode of practice. FIG. 2A of this figure is a signal waveform diagram when the rotor 113 has rotated, and FIG. 2B of the figure is a signal waveform diagram when the rotor 113 has not rotated.

Hereinafter, the operation of the electronic timepiece according to the present mode of practice is described in detail using FIGS. 1 and 2.

First, operations in cases where the motors 101 and 102 are rotationally driven to perform an operation for displaying a measured time and an operation for displaying the time are described.

Where the hour hand is rotationally driven, the switching circuit 108 is switched to the side of the driving circuit 104. Under this state, a pulse signal produced by the pulse synthesizing circuit 106 is input to the control circuit 107. The control circuit 107 outputs a control pulse to the driving circuit 104 via the switching circuit 108. The driving circuit 104 outputs a normal drive pulse of a given width to the motor 102 in response to the control pulse. Thus, the rotor 116 is rotationally driven. The time hands (hour hand, minute hand, and second hand) (not shown) that are fingers are rotationally driven.

On the other hand, where the chronograph hand is rotationally driven, the switching circuit 108 is switched to the side of the driving circuit 103. Under this state, the pulse signal produced by the pulse synthesizing circuit 106 is input to the control circuit 107. The control circuit 107 outputs a control pulse to the driving circuit 103 via the switching circuit 108. The driving circuit 103 outputs a normal drive pulse of a given width to the motor 101 in response to the control pulse. Thus, the rotor 113 is rotationally driven, and the chronograph hand (not shown) that is a finger is rotationally driven.

Next, operations when rotation of the motor 101 is detected are described.

In this case, the switching circuit 108 is switched to thereby stop the operation of the driving circuit 104. The rotation detection circuit 109 is connected with the coil 115 of the motor 102. That is, all transistors constituting the driving circuit 104 of the motor 102 are turned off by the switching circuit 108. The rotation detection circuit 109 is connected with the coil 115 of the motor 102.

Under this state, as shown in FIG. 2, if a control pulse A is output from the control circuit 107 to the driving circuit 103, the driving circuit 103 outputs a drive pulse C of normal width to the motor 101.

An induction voltage B induced from the motor 101 is picked up in the coil 115 by electromagnetic induction. Where the rotor 113 has rotated through 180 degrees by the driving described above, the induction voltage B shown in FIG. 2(a) is induced in the coil 115. On the other hand, where the rotor 113 is not rotated by the above-described driving, the induction voltage B shown in FIG. 2(b) is induced in the coil 115.

That is, the induction voltages B of FIGS. 2(a), (b) produce five points (zero cross points) at which the level of the induction voltage becomes zero where the rotor 113 has rotated during the period when the control pulse A is being applied. Where the rotor 113 has not rotated, there are four zero cross points. That is, the number of zero cross points is greater where the rotor 113 has rotated than where it has not rotated. Accordingly, the rotation detection circuit 109 detects whether the number of the zero cross points of the induction voltage during the application period of the control pulse A is more than a given number. Thus, it is possible to detect whether the rotor 113 has rotated or not.

Of course, the times at which zero cross points are produced by rotation and non-rotation of the rotor 113 are different.

For instance, it is possible to detect whether the rotor 113 has rotated or not, by detecting whether the second zero-crossing point of the induction voltage during the application period of the control pulse A is a given time or not by the rotation detection circuit 109.

If the rotation detection circuit 109 detects that the motor 101 has not rotated, it outputs a non-rotation detection signal indicating non-rotation to the control circuit 107. The control circuit 107 controls the driving circuit 103 to cause a drive pulse (corrective pulse) of higher energy (e.g., wider pulse width than normal) than the normal drive pulse to be supplied to the motor 101 in response to the non-rotation detection signal. Thus, the motor 101 is again driven by the higher-energy drive pulse and thus certainly rotated.

On the other hand, if the rotation detection circuit 109 detects that the motor 101 has rotated, it outputs a rotation detection signal indicating that the motor has rotated to the control circuit 107. The control circuit 107 controls the driving circuit 103 to interrupt the drive pulse taking account of a preset delay time in response to the rotation detection signal.

The starting point of the interruption timing of the drive pulse is the zero cross point (flux linkage zero point), and the interruption timing is a delay time in which the rotor 113 easily stops at a stable still point. The rotor 113 is quickly stopped at the stable still point and thus high-speed and stable rotation of the rotor 113 is obtained.

As mentioned thus far, the electronic timepiece according to the present mode of practice has the stepping motor 101 having the rotor-driving coil 112 wound around the stator 111 and the rotor 113 rotated by a magnetic flux produced in the stator 111 by a drive pulse supplied to the rotor-driving coil 112 and the driving circuit 103 for supplying a drive pulse to the rotor-driving coil 112, wherein a finger is rotated by rotation of the rotor 113, the electronic timepiece being characterized in that it has the detection coil 115 for detecting a signal induced by electromagnetic coupling with the rotor-driving coil 112 and the rotation detection circuit 109 for detecting whether the rotor 113 has rotated or not, based on the detection signal produced in the detection coil 115.

In the past, a decision has been made by the state of rotation of the rotor after interruption of the drive pulse. In the present mode of practice, because of the configuration described above, the induced voltage is detected by electromagnetic induction by means of a coil placed close and juxtaposed to the motor 101 (it may be the driving coil 115 of the separate motor 102), whereby the state of rotation of the rotor 113 is detected. Therefore, the presence or absence of rotation of the rotor 113 can be detected within the range of the drive pulse.

Furthermore, since the drive pulse is interrupted using a flux linkage zero point as a starting point, decrease in the consumed electric power can be achieved.

Furthermore, the relation between the flux linkage zero point and rotor stable still position is fixed for each motor. It is possible to set, by means of design, a drive pulse interruption time that facilitates stopping at the rotor stable still point using a flux linkage zero point as its starting point. High-speed and stable rotor rotation can be obtained.

In addition, in the present mode of practice, the rotor-driving coil 115 of the stepping motor 102 different from the stepping motor 101 is also used as the detection coil and so any special detection coil does not need to be mounted.

According to an electronic timepiece of the present invention, the presence or absence of rotation of a rotor can be detected in early stages.

Additionally, rotation of the rotor can be made faster by detecting the presence or absence of rotation of the rotor in early stages.

What is claimed is:

1. An electronic timepiece comprising:
a first stepping motor having a first rotor-driving coil wound around a first stator and a first rotor rotated by a magnetic flux produced in the first stator by a drive pulse supplied to the first rotor-driving coil;
a first driving pulse-producing circuit for supplying the drive pulse to the first rotor-driving coil;
a first finger is rotated by rotation of the first rotor;
a detection coil for detecting a signal induced by electromagnetic coupling with the first rotor-driving coil; and
a rotation detection circuit for detecting whether the first rotor has rotated or not, based on the detection signal produced in the detection coil.

2. An electronic timepiece according to claim 1, wherein the rotation detection means detects that the first rotor has rotated when zero cross points of the detection signal are detected to be more than a given number while the drive pulse is being supplied to the first rotor-driving coil.

3. An electronic timepiece according to claim 1, wherein the first driving pulse-producing circuit interrupts the drive pulse when the rotation detection circuit detects that the first rotor has rotated.

4. An electronic timepiece according to claim 1, wherein the first drive pulse-producing circuit supplies a corrective pulse greater in energy than the drive pulse to the first rotor-driving coil when the rotation detection circuit detects that the first rotor is not rotating.

5. An electronic timepiece according to claim 1, further comprising a second stepping motor having a second rotor-driving coil wound around a second stator and a second rotor rotated by a magnetic flux produced in the second stator by a drive pulse supplied to the second rotor-driving coil, a second drive pulse-producing circuit for supplying the drive pulse to the second rotor-driving coil, a second finger is rotated by rotation of the second rotor, and a switching circuit for causing the second rotor-driving coil to act as the detection coil.

6. An electronic timepiece according to claim 5, wherein the first stepping motor is a stepping motor for driving a chronograph hand, and the second stepping motor is a stepping motor for driving an hour hand.
